(19) United States
(12) Patent Application Publication
(10) Pub. No.: US 2023/0276219 A1
(43) Pub. Date: Aug. 31, 2023

(54) Reporting of Secondary Node Related Operations

(71) Applicant: Telefonaktiebolaget LM Ericsson (publ), Stockholm (SE)

(72) Inventors: Marco Belleschi, Solna (SE); Pradeepa Ramachandra, Linköping (SE)

(21) Appl. No.: 18/028,274

(22) PCT Filed: Oct. 13, 2021
(86) PCT No.: PCT/IB2021/059414

§ 371 Date: Mar. 24, 2023

Related U.S. Application Data
(60) Provisional application No. 63/090,949, filed on Oct. 13, 2020.

(51) Int. Cl. H04W 8/08

(52) U.S. Cl. CPC H04W 8/08

(57) ABSTRACT

Systems and methods are disclosed herein for reporting of Primary Secondary Cell (PSCell) change in mobility history information. In one embodiment, a method performed by a wireless device comprises generating a report that comprises mobility history information, the mobility history information comprising, for a certain Primary Cell (PCell), with which the wireless device is or was configured, information related to one or more Secondary Node (SN) related operations. The information related to the one or more SN related operations comprises information that indicates whether the wireless device was configured with a SN or not while being configured with the certain PCell. The method further comprises sending the report to a network node. The Master Node (MN), for example, can use this information to understand the coverage of the SN and, based on this, enable faster Dual Connectivity (DC) setup.

### RELATED APPLICATIONS

This application claims the benefit of provisional patent application Ser. No. 63/090,949, filed Oct. 13, 2020, the disclosure of which is hereby incorporated herein by reference in its entirety.

### FIELD OF THE DISCLOSURE

The present disclosure relates to mobility history information in a cellular communications network.

### BACKGROUND

### Mobility History Information (MHI)

In Third Generation Partnership Project (3GPP) Long Term Evolution (LTE), the source evolved or enhanced Node B (eNB) collects and stores User Equipment (UE) History information for as long as the UE stays in one of its cells. The resulting information is then used in subsequent handover preparations by means of the Handover Preparation procedures, which provide the target eNB with a list of previously visited cells and associated (per-cell) information elements. The Handover Preparation procedures also trigger the target eNB to start collection and storage of UE history information and thus to propagate the collected information. The collection is done by requesting mobility history information from the UE using the UE information request message.

A UE triggered to collect mobility history information in LTE will, upon change of cells (intra- or inter-Radio Access Technology (RAT), in RRC_CONNECTED or RRC_IDLE), log the global cell identity or physical cell identity and carrier frequency of the previous cell, as well as the time spent in the cell. If a UE triggered to collect mobility history information will fall out of service or use another RAT, it will upon entering Evolved Universal Terrestrial Radio Access (E-UTRA) again, log the time spent outside E-UTRA. This information is the information sent to the eNB requesting mobility history information from the UE.

Essentially the same functionalities for mobility history information report have been specified also in 3GPP New Radio (NR) in Release16 and extended RRC_INACTIVE mode, as well. In particular, in NR, upon change of suitable cell consisting of Primary Cell (PCell) in RRC_CONNECTED or serving cell in RRC_INACTIVE (for NR cell) or in RRC_IDLE (for NR or E-UTRA cell), to another NR or E-UTRA cell, or when entering ‘any cell selection’ state from ‘camped normally’ state in NR or LTE, the UE includes the global cell identity (if available) of that cell in the field visitedCellId of VarMobilityHistoryReport. Otherwise, if the global cell identity of that cell is not available, the UE includes the physical cell identity and carrier frequency of that cell in the field visitedCellId of VarMobilityHistoryReport. Additionally, the UE sets the time spent in the previous PCell/serving cell in the VisitedCellInfo of VarMobilityHistoryReport.

Similarly related to transitions from out-of-coverage to in-coverage, it is specified that upon entering NR (in RRC_IDLE, RRC_INACTIVE or RRC_CONNECTED) or E-UTRA (in RRC_IDLE or RRC_CONNECTED) while previously in ‘any cell selection’ state or ‘camped on any cell’ state in NR or LTE, the UE sets the field timeSpent to the time spent in ‘any cell selection’ state and/or ‘camped on any cell’ state in NR or LTE in the VisitedCellInfo of VarMobilityHistoryReport.

### Dual Connectivity

FIG. 1 elaborates the multiple Architecture Options available in 3GPP Release 15. Currently, Release 15 supports up to seven architecture options, which include both standalone and non-standalone scenarios. The present disclosure focuses on the architecture options supporting dual connectivity and potential support of Minimization of Drive Tests (MDT) in those options, specifically Option 3: E-UTRA-NR Dual Connectivity (EN-DC); Option 4: NR-E-UTRA Dual Connectivity (NE-DC); and Option 7: Next Generation Dual Connectivity (NGEN-DC).

As part of MR-DC configuration, each UE is configured with two separate scheduled cell groups, namely a Master Cell Group (MCG) and a Secondary Cell Group (SCG). The MCG belongs to the Master Node (MN), and the SCG belongs to the Secondary Node (SN). Based on the MR-DC type, the MN could be a RAN node controlling an LTE cell or an NR cell, and the SN could be a RAN node controlling an LTE cell or an NR cell.

Bearer Termination Options in MR-DC. An important aspect to understand in MR-DC is the bearer termination. FIG. 2 shows the bearer types based on termination points. There are mainly two types of bearer termination in MR-DC, namely: MN terminated bearer and SN terminated bearer. A MN terminated bearer in MR-DC is a radio bearer for which Packet Data Convergence Protocol (PDCP) is located in the MN. A SN terminated bearer in MR-DC is a radio bearer for which PDCP is located in the SN.

### Mobility History Information Enhancements

Some possible improvements to the current mobility history report that have been discussed in 3GPP are the inclusion of other information that could help the network to understand UE movements and mobility patterns in a better way. For this, sensor information could be used, such as Inertial Measurement Unit (IMU) sensor information. Other information, such as UE position, could also be of interest to include in the mobility history information.

### SUMMARY

Systems and methods are disclosed herein for reporting of Primary Secondary Cell (PSCell) change in mobility history information. In one embodiment, a method performed by a wireless device comprises generating a report that comprises mobility history information, the mobility history information comprising, for a certain Primary Cell (PCell), with which the wireless device is or was configured, information related to one or more Secondary Node (SN) related operations. The information related to the one or more SN related operations comprises information that indicates whether the wireless device was configured with a SN or not while being configured with the certain PCell. The method further comprises sending the report to a network node. Reporting this information to the network may be beneficial both for the Master Node (MN) and the SN. The MN, for example, can use this information to understand the coverage of the SN and, based on this, enable faster Dual Connectivity (DC) setup.

In one embodiment, the one or more SN related operations comprise: (a) a SN modification, (b) a SN change, (c) removal of a PSCell configuration for the wireless device, (d) addition of a PSCell configuration for the wireless device, (e) the wireless device not being configured with a SN, or (f) a combination of any two or more of (a)-(e).

In one embodiment, the information related to the one or more SN related operations comprises a mobility history of the wireless device associated to the one or more SN related operations.

In one embodiment, the information related to the one or more SN related operations comprises a list that comprises one or more entries, each of the one or more entries comprising information that indicates PSCell visited by the wireless device while being configured with the certain PCell or information that indicates no SN configuration. In one embodiment, the list is in chronological order. In one embodiment, the list further comprises one or more entries that indicate one or more PSCells visited by the wireless device while being configured with the certain PCell and one or more entries that indicates no SN configuration. In one embodiment, the information related to the one or more SN related operations further comprises information collected by the wireless device related to each entry in the list. In one embodiment, the information collected by the wireless device related to each entry in the list comprises: (A) an amount of time spent in a respective PSCell or an amount of time spent with no SN configuration, (B) an indication of a cause that triggers the wireless device into a respective PSCell to into having no SN configuration, (C) cell quality experienced in a respective PSCell, (D) a mobility state of the wireless device, (E) a mobility state of the wireless device at a first moment of being configured with a respective PSCell or with no SN configuration, (F) a mobility state of the wireless device at a last moment of being configured with a respective PSCell or with no SN configuration, or (G) a combination of any two or more of A-F.

In one embodiment, the information related to the one or more SN related operations comprises, in chronological order, states related to the one or more SN related operations while the wireless device is or was configured with the PCell. In one embodiment, the states related to the one or more SN related operations comprise one or more states in which the wireless device is configured with a PSCell and one or more states in which the wireless device has no SN configuration. In one embodiment, the information related to the one or more SN related operations further comprises, for each of the states related to the one or more SN related operations: (A) an amount of time spent in the state, (B) an indication of a cause that triggers the wireless device into the state, (C) cell quality experienced in the state, (D) a mobility state of the wireless device in the state, (E) a mobility state of the wireless device at a first moment of being configured with a respective PSCell for the state, (F) a mobility state of the wireless device at a last moment of being configured with a respective PSCell for the state, or (G) a combination of any two or more of A-F.

Corresponding embodiments of a wireless device for a wireless network are also disclosed. In one embodiment, a wireless device for a wireless network is adapted to generate a report that comprises mobility history information, the mobility history information comprising, for a certain PCell with which the wireless device is or was configured, information related to one or more SN related operations. The information related to the one or more SN related operations comprises information that indicates whether the wireless device was configured with a SN or not while being configured with the certain PCell. The wireless device is further adapted to send the report to a network node.

In one embodiment, the wireless device comprises radio front end circuitry and processing circuitry associated with the radio front end circuitry. The processing circuitry is configured to cause the wireless device to generate the report and send the report to the network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the multiple architecture options available in Third Generation Partnership Project (3GPP) Release 15;

FIG. 2 illustrates bearer types based on termination points;

FIG. 3 is a flow chart that illustrates the operation of a wireless device in accordance with one embodiment of the present disclosure;

FIG. 4 illustrates one example of a wireless network in which embodiments of the present disclosure may be implemented;

FIG. 5 illustrate a UE in accordance with some embodiments;

FIG. 6 illustrates a virtualization embodiment in accordance with some embodiments;

FIG. 7 illustrates a telecommunications network connected via an intermediate network to a host computer in accordance with some embodiments;

Figure QQ5 illustrates a host computer communicating via a base station with a UE over a partially wireless connection in accordance with some embodiments;

FIGS. 9, 10, 11, and 12 illustrates methods implemented in a communication system including a host computer, a base station, and a UE in accordance with some embodiments; and

FIG. 13 is a flow chart that illustrates a method in accordance with one embodiment of the present disclosure.

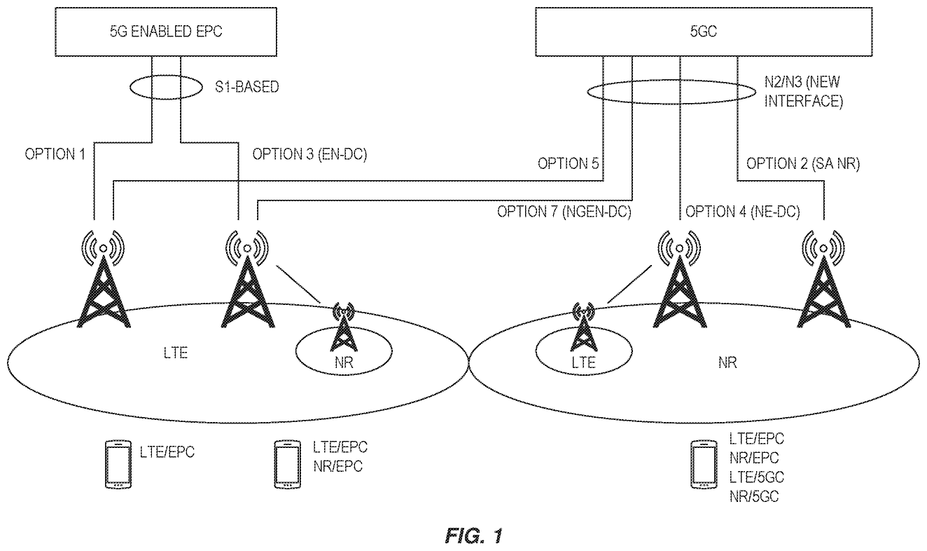

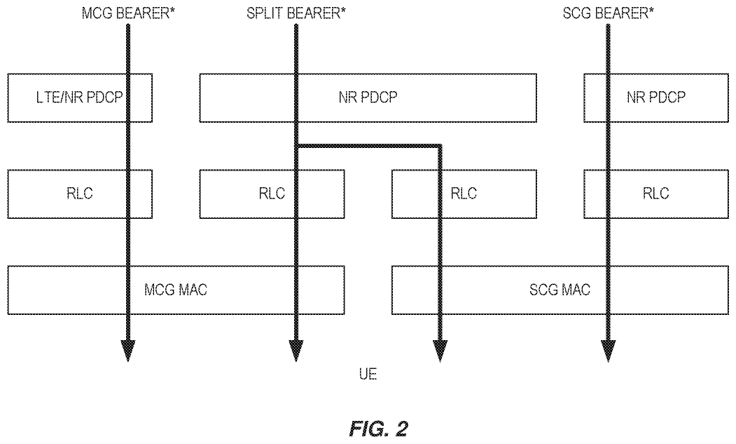

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

There currently exist certain challenges. In the current 3GPP specification, the Mobility History Information (MHI) report is filled only in two cases. First, the MHI report is filled when there is a change in the Primary Cell (PCell) in RRC_CONNECTED or serving cell in RRC_INACTIVE (for New Radio (NR) cell) or in RRC_IDLE (for NR or Evolved Universal Terrestrial Radio Access (E-UTRA) cell). Second, the MHI report is filled when the User Equipment (UE) enters network coverage while previously in ‘any cell selection’ state or ‘camped on any cell’ state. For the case of Primary Cell (PCell)/serving cell, the above methods work fine, since a User Equipment (UE) in RRC_CONNECTED mode can only transit from one PCell to another or from one serving cell to another serving cell when in RRC_INACTIVE or in RRC_IDLE, or leave the network coverage.

However, the teachings of the present disclosure recognize that, for the case of the Primary Secondary Cell (PSCell) change, more scenarios can be envisaged: a Secondary Node (SN) change is triggered for the UE from PSCell1 to PSCell2 following, for example, an SN modification/change; the PSCell configuration is removed for the UE, for example, following an SN node release; and the PSCell is configured for the UE, for example, following an SN addition procedure.

Certain aspects of the present disclosure and their embodiments may provide solutions to these or other challenges. According to one embodiment, a method includes tracking the mobility history associated with SN operations, such as whether the UE was configured with SN or not. In the case where SN is configured, the method includes the UE listing the set of visited PSCells and, for each visited PSCell, listing a plurality of the information that the UE may collect when configured with such PSCell.

There are, proposed herein, various embodiments which address one or more of the issues disclosed herein. According to one embodiment, a method performed by a wireless device (e.g., a UE) for allowing tracking of mobility history associated with SN operations includes writing, by the wireless device in a report, events associated with configuration of one or more PSCells that were configured when the wireless device was configured with a PCell. According to another embodiment, a method performed by a wireless device for allowing tracking of mobility history associated with SN operations includes writing, by the wireless device in a report, events associated with no PSCell configuration when the wireless device was configured with a PCell.

Certain embodiments may provide one or more of the following technical advantages. The teachings of the disclosure recognize that the current MHI framework only considers change of the PCell to be reported. Therefore, the present disclosure extends the current MHI framework to include PSCell-related changes. For example, certain embodiments allow the network to track the mobility history associated with SN operations, and to possibly figure out the quality of a certain PSCell. Including the PSCell changes may be beneficial both for the Master Node (MN) and SN. The MN, for example, can use this information to understand the coverage of the SN and, based on this, enable faster Dual Connectivity (DC) setup. For example, the MN can figure out that a certain cell has good performances if the time spent was high. On the other hand, the SN can use this information to enable a more efficient SN change in the “SN initiated change” framework. For example, the SN can suggest, to the PCell, another PSCell that is supposed to provide good performance. Regarding the fetching of the PSCell information, the MN may fetch and forward the information to the SN, or it could be the SN itself that triggers the request of PSCell-related information, so that the SN can retrieve this information whenever it is needed.

As stated above, the teachings of the disclosure recognize that the current MHI framework only considers change of the PCell to be reported. The present disclosure extends such a framework to include PSCell-related changes.

In the present disclosure, it is considered the case in which a UE is in RRC_CONNECTED mode and is configured with a PCell. The present disclosure comprises a method for the UE to indicate, in the MobilityHistoryReport, the events associated with the configuration of one or more PSCells that were configured when the UE was configured with a certain PCell, and the events of no PSCell configuration when the UE was configured with a certain PCell. Such events for a visited PCell are reported in in chronological order within the MobilityHistoryReport. For example, the UE may list in chronological order the following states related to SN operations while configured with a certain PCell1:
no SN configuration;
configuration of PSCell1;
configuration of PSCell2—implying that an SN handover was performed from PSCell1 to PSCell2; and
no SN configuration (again).

Associated with each of the above states, the UE may also include a plurality of information such as:
The time spent with a certain PSCell configured or with no SN configuration;
An indication indicating the cause that triggers the UE in that state, such as:
   For the case of handover between PSCell1 and PSCell2, a flag indicating the reception of an RRCReconfiguration message including a different Secondary Cell Group (SCG);
   For the case of “no SN configuration,”
      A flag indicating the reception of Multi-Radio Dual Connectivity (MR-DC) release without Radio Link Failure (RLF) triggered yet in the PSCell and reception of MR-DC release after RLF triggered in the PSCell;
      A flag indicating that the UE is in “No SN configuration” state due to an RLF experienced in the SNNo specific flag (e.g., cause “initialState”), in case, e.g., the UE is in “no SN configuration state” since configured with a PCell; Cell quality experienced in the respective state, e.g., average Reference Signal
Received Power (RSRP)/Reference Signal Received Quality (RSRQ)/Received Signal Strength Indicator (RSSI) of the configured PSCell and/or of one or more neighboring cells;
The mobility state of the UE in the respective state;
The mobility state of the UE at the first moment of being configured with the said PSCell; and
The mobility state of the UE at the last moment of being configured with the said PSCell′

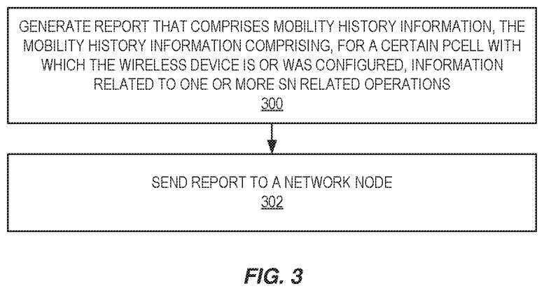

In this regard, FIG. 3 is a flow chart that illustrates the operation of a wireless device (e.g., a UE) in accordance with at least some aspects of the embodiments described herein. As illustrated, the wireless device generates a report that comprises mobility history information, where the mobility history information comprises, for a certain PCell with which the wireless device is or was configured, information related to one or more SN related operations (step 300). As described above, this report may be generated by the wireless device by writing, or logging, information collected by the wireless device relating to SN operations while the wireless device is configured with the certain PCell. As discussed above, the information related to the SN related operations includes information that indicates whether the wireless device was configured with a SN or not while being configured with the certain PCell. For instance, as described herein, in one embodiment, the information is a list that includes an entry for each PSCell visited by the wireless device while being configured with the PCell and an entry for each instance of the wireless device having no SN configuration while being configured with the PCell. Preferably, the list is in chronological order. For each entry in the list, the information may further include time spent in a respective PSCell or with no SN configuration, an indication of a cause that triggers the wireless device into a respective PSCell or into having no SN configuration, cell quality experienced in a respective PSCell, a mobility state of the wireless device, a mobility state of the wireless device at a first moment of being configured with a respective PSCell or with no SN configuration, a mobility state of the wireless device at a last moment of being configured with a respective PSCell or with no SN configuration, or any combination thereof. As discussed above, in another embodiment, the information includes information collected by the wireless device while in a number of states while configured with the certain PCell. The wireless device sends the report to the network (e.g., to a network node) (step 302).

The above methods can be represented by the following signaling, where the legacy visitedCellId-r16 IE is used to represent the (E-UTRA/NR) PCell, and visitedCellInfoList-r17 that may include in chronological order the list of (E-UTRA/NR) PSCells visited when the UE was configured with the concerned PCell and an indication of whether any SN was configured with that PCell.

### Example Signaling

MobilityHistoryReport-r16 ::= VisitedCellInfoList-r16
VisitedCellInfoList-r16 ::= SEQUENCE (SIZE (1..maxCellHistory-r16)) OF VisitedCellInfo-r16

| | |
|---|---|
| VisitedCellInfo-r16 ::= | SEQUENCE { |
| visitedCellId-r16 | CHOICE { |
| nr-CellId-r16 | CHOICE { |
| cgi-Info | CGI-Info-Logging-r16, |
| pci-arfcn-r16 | SEQUENCE { |
| physCellId-r16 | PhysCellId, |
| carrierFreq-r16 | ARFCN-ValueNR |

```
      }
    },
```

| | |
|---|---|
| eutra-CellId-r16 | CHOICE { |
| cellGlobalId-r16 | CGI-InfoEUTRA, |
| pci-arfcn-r16 | SEQUENCE { |
| physCellId-r16 | EUTRA-PhysCellId, |
| carrierFreq-r16 | ARFCN-ValueEUTRA |

```
      }
    }
```

| | |
|---|---|
| } | OPTIONAL, |
| timeSpent-r16 | INTEGER (0..4095), |

```
  visitedCellInfoList-r17 ::= SEQUENCE (SIZE (1..maxCellHistory-r16)) OF VisitedCellInfo-r17
      ...
}
VisitedCellInfo-r17 ::= SEQUENCE {
```

| | |
|---|---|
| visitedCellId-r16 | CHOICE { |
| nr-CellId-r16 | CHOICE { |
| cgi-Info | CGI-Info-Logging-r16, |
| pci-arfcn-r16 | SEQUENCE { |
| physCellId-r16 | PhysCellId, |
| carrierFreq-r16 | ARFCN-ValueNR |

```
      }
    },
```

| | |
|---|---|
| eutra-CellId-r16 | CHOICE { |
| cellGlobalId-r16 | CGI-InfoEUTRA, |
| pci-arfcn-r16 | SEQUENCE { |
| physCellId-r16 | EUTRA-PhysCellId, |
| carrierFreq-r16 | ARFCN-ValueEUTRA |

```
      }
    },
```

| | |
|---|---|
| noSN | ENUMERATED {true} OPTIONAL |
| } | OPTIONAL, |
| timeSpent-r16 | INTEGER (0..4095), |
| stateCause | ENUMERATED {initialState, handover, release, RLF, |

SCG-Failure},

| | |
|---|---|
| measResult | MeasResultListNR, |
| mobilityState-r16 | ENUMERATED {normal, medium, high, spare}, |
| mobilityStateStart-r16 | ENUMERATED {normal, medium, high, spare}, |
| mobilityStateEnd-r16 | ENUMERATED {normal, medium, high, spare} |

...
}

In a separate method, it is disclosed when the above information related to SN operations should be included in the MHI for a given PCell, for example, in the visitedCellInfoList-r17 IE described above.
A given PSCell1 (and related plurality of information) is included in the MHI for a given PCell when the UE is handed over from PSCell1 to PSCell2.
A given PSCell1 (and related plurality of information) is included in the MHI for a given PCell1 when the UE is handed over from PCell1 to PCell2.
A given PSCell1 (and related plurality of information) is included in the MHI for a given PCell1 when the connection of the UE with PCell1 is released or lost, for example, as a result of the UE transiting from RRC_CONNECTED mode to RRC_IDLE, or RRC_INACTIVE, or as a result of RLF.
A given PSCell1 (and related plurality of information) is included in the MHI for a given PCell1 when the PSCell1 is released for the UE (for example, MR-DC is released).

Similarly, the “No SN” flag may be included in the MHI for a given PCell, for example, in the visitedCellInfoList-r17 IE, when the following occurs:
A PSCell is configured for the UE when the UE is connected to a certain PCell. For example, SN is configured, and the UE does not have SN configured at the moment of PSCell configuration.
The UE performs a handover from PCell1 to PCell2, and at the moment of the handover the UE does not have SN configured.
The connection of the UE with PCell1 is released or lost, e.g., as a result of the UE transiting from RRC_CONNECTED mode to RRC_IDLE, or RRC_INACTIVE, or as a result of RLF, and the UE does not have SN configured.

The above has been described in the context of a UE initially indicating in the MobilityHistoryReport certain information, as described above. In addition, such information could be written into other reports. Further, such information could also be written by other devices, such as by a base station or by a host computer, for further use, either originally or by writing the information written to the report written by the UE by rewriting the underlying information itself or by writing (including storing) a report previously written by the UE.

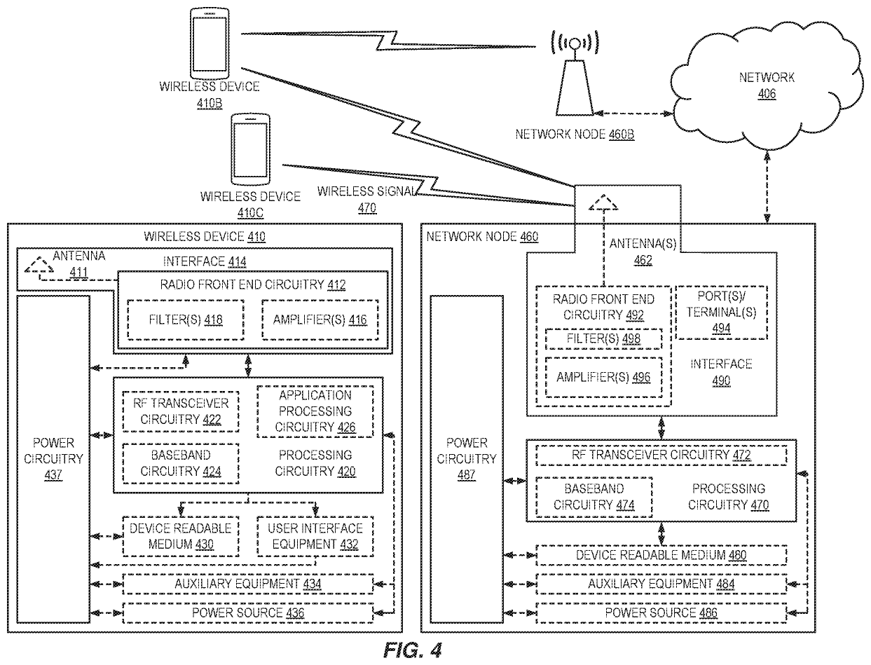

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 406, network nodes 460 and 460b, and WDs 410, 410b, and 410c. In practice, a wireless network may further include any additional elements suitable to support communication between wireless devices or between a wireless device and another communication device, such as a landline telephone, a service provider, or any other network node or end device. Of the illustrated components, network node 460 and wireless device (WD) 410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR Node Bs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 460 includes processing circuitry 470, device readable medium 480, interface 490, auxiliary equipment 484, power source 486, power circuitry 487, and antenna 462. Although network node 460 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions, and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple RAM modules).

Similarly, network node 460 may be composed of multiple physically separate components (e.g., a Node B component and a RNC component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple Node Bs. In such a scenario, each unique Node B and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). Network node 460 may also include multiple sets of the various illustrated components for different wireless technologies integrated into network node 460, such as, for example, GSM, WCDMA, LTE, NR, WiFi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SOC).

In some embodiments, processing circuitry 470 may include one or more of radio frequency (RF) transceiver circuitry 472 and baseband processing circuitry 474. In some embodiments, radio frequency (RF) transceiver circuitry 472 and baseband processing circuitry 474 may be on separate chips (or sets of chips), boards, or units, such as radio units and digital units. In alternative embodiments, part or all of RF transceiver circuitry 472 and baseband processing circuitry 474 may be on the same chip or set of chips, boards, or units

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionality may be provided by processing circuitry 470 without executing instructions stored on a separate or discrete device readable medium, such as in a hard-wired manner In any of those embodiments, whether executing instructions stored on a device readable storage medium or not, processing circuitry 470 can be configured to perform the described functionality. The benefits provided by such functionality are not limited to processing circuitry 470 alone or to other components of network node 460, but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be considered to be integrated.

Interface 490 is used in the wired or wireless communication of signalling and/or data between network node 460, network 406, and/or WDs 410. As illustrated, interface 490 comprises port(s)/terminal(s) 494 to send and receive data, for example to and from network 406 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or WDs via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 494, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 490 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 486. Power source 486 and/or power circuitry 487 may be configured to provide power to the various components of network node 460 in a form suitable for the respective components (e.g., at a voltage and current level needed for each respective component). Power source 486 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 486 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. WD 410 may include multiple sets of one or more of the illustrated components for different wireless technologies supported by WD 410, such as, for example, GSM, WCDMA, LTE, NR, WiFi, WiMAX, or Bluetooth wireless technologies, just to mention a few. These wireless technologies may be integrated into the same or different chips or set of chips as other components within WD 410.

Antenna 411 may include one or more antennas or antenna arrays, configured to send and/or receive wireless signals, and is connected to interface 414. In certain alternative embodiments, antenna 411 may be separate from WD 410 and be connectable to WD 410 through an interface or port. Antenna 411, interface 414, and/or processing circuitry 420 may be configured to perform any receiving or transmitting operations described herein as being performed by a WD. Any information, data and/or signals may be received from a network node and/or another WD. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 414 is connected to antenna 411 and processing circuitry 420, and is configured to condition signals communicated between antenna 411 and processing circuitry 420. Radio front end circuitry 412 may be coupled to or a part of antenna 411. In some embodiments, WD 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or WDs via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 410 components, such as device readable medium 430, WD 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more of RF transceiver circuitry 422, baseband processing circuitry 424, and application processing circuitry 426. In other embodiments, the processing circuitry may comprise different components and/or different combinations of components. In certain embodiments processing circuitry 420 of WD 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionality described herein as being performed by a WD may be provided by processing circuitry 420 executing instructions stored on device readable medium 430, which in certain embodiments may be a computer-readable storage medium. In alternative embodiments, some or all of the functionality may be provided by processing circuitry 420 without executing instructions stored on a separate or discrete device readable storage medium, such as in a hard-wired manner In any of those particular embodiments, whether executing instructions stored on a device readable storage medium or not, processing circuitry 420 can be configured to perform the described functionality. The benefits provided by such functionality are not limited to processing circuitry 420 alone or to other components of WD 410, but are enjoyed by WD 410 as a whole, and/or by end users and the wireless network generally.

Processing circuitry 420 may be configured to perform any determining, calculating, or similar operations (e.g., certain obtaining operations) described herein as being performed by a WD. These operations, as performed by processing circuitry 420, may include processing information obtained by processing circuitry 420 by, for example, converting the obtained information into other information, comparing the obtained information or converted information to information stored by WD 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 420. In some embodiments, processing circuitry 420 and device readable medium 430 may be considered to be integrated.

User interface equipment 432 may provide components that allow for a human user to interact with WD 410. Such interaction may be of many forms, such as visual, audial, tactile, etc. User interface equipment 432 may be operable to produce output to the user and to allow the user to provide input to WD 410. The type of interaction may vary depending on the type of user interface equipment 432 installed in WD 410. For example, if WD 410 is a smart phone, the interaction may be via a touch screen; if WD 410 is a smart meter, the interaction may be through a screen that provides usage (e.g., the number of gallons used) or a speaker that provides an audible alert (e.g., if smoke is detected). User interface equipment 432 may include input interfaces, devices, and circuits and output interfaces, devices, and circuits. User interface equipment 432 is configured to allow input of information into WD 410, and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from WD 410, and to allow processing circuitry 420 to output information from WD 410. User interface equipment 432 may include, for example, a speaker, a display, vibrating circuitry, a USB port, a headphone interface, or other output circuitry. Using one or more input and output interfaces, devices, and circuits, of user interface equipment 432, WD 410 may communicate with end users and/or the wireless network, and allow them to benefit from the functionality described herein.

Auxiliary equipment 434 is operable to provide more specific functionality which may not be generally performed by WDs. This may comprise specialized sensors for doing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. WD 410 may further comprise power circuitry 437 for delivering power from power source 436 to the various parts of WD 410 which need power from power source 436 to carry out any functionality described or indicated herein. Power circuitry 437 may in certain embodiments comprise power management circuitry. Power circuitry 437 may additionally or alternatively be operable to receive power from an external power source; in which case WD 410 may be connectable to the external power source (such as an electricity outlet) via input circuitry or an interface such as an electrical power cable. Power circuitry 437 may also in certain embodiments be operable to deliver power from an external power source to power source 436. This may be, for example, for the charging of power source 436. Power circuitry 437 may perform any formatting, converting, or other modification to the power from power source 436 to make the power suitable for the respective components of WD 410 to which power is supplied.

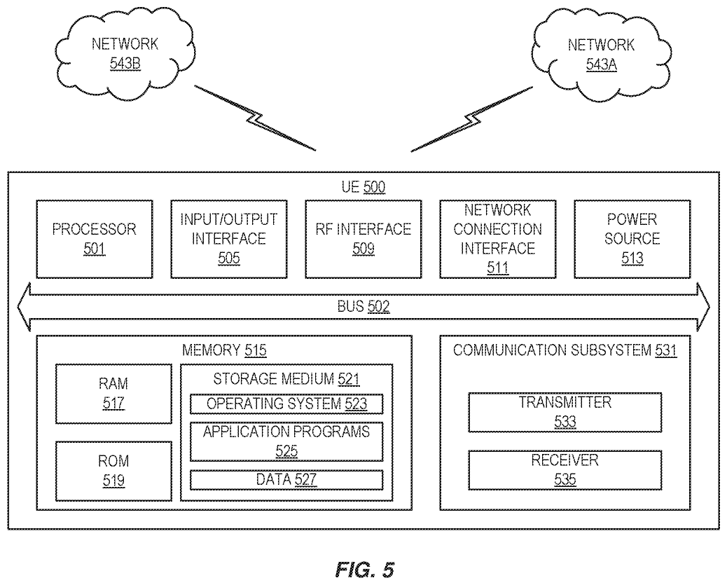

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 5200 may be any UE identified by the 3rd Generation Partnership Project (3GPP), including a NB-IoT UE, a machine type communication (MTC) UE, and/or an enhanced MTC (eMTC) UE. UE 500, as illustrated in FIG. 5, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 500 includes processing circuitry 501 that is operatively coupled to input/output interface 505, radio frequency (RF) interface 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. UE 500 may be configured to use an output device via input/output interface 505. An output device may use the same type of interface port as an input device. For example, a USB port may be used to provide input to and output from UE 500. The output device may be a speaker, a sound card, a video card, a display, a monitor, a printer, an actuator, an emitter, a smartcard, another output device, or any combination thereof. UE 500 may be configured to use an input device via input/output interface 505 to allow a user to capture information into UE 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, SONET, ATM, or the like. Network connection interface 511 may implement receiver and transmitter functionality appropriate to the communication network links (e.g., optical, electrical, and the like). The transmitter and receiver functions may share circuit components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (I/O), startup, or reception of keystrokes from a keyboard that are stored in a non-volatile memory. Storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by UE 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow UE 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a local-area network (LAN), a wide-area network (WAN), a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of UE 500.

The features, benefits and/or functions described herein may be implemented in one of the components of UE 500 or partitioned across multiple components of UE 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware.

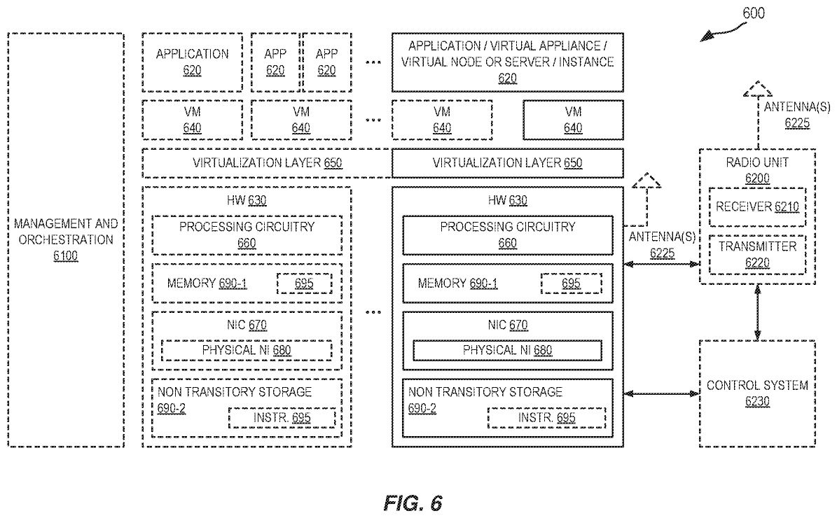

FIG. 6 is a schematic block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 600 hosted by one or more of hardware nodes 630. Further, in embodiments in which the virtual node is not a radio access node or does not require radio connectivity (e.g., a core network node), then the network node may be entirely virtualized.

The functions may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualization environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualization environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660. Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualization layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualization layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualization layer 650, which may sometimes be referred to as a virtual machine monitor (VMM). Virtualization layer 650 may present a virtual operating platform that appears like networking hardware to virtual machine 640.

As shown in FIG. 6, hardware 630 may be a standalone network node with generic or specific components. Hardware 630 may comprise antenna 6225 and may implement some functions via virtualization. Alternatively, hardware 630 may be part of a larger cluster of hardware (e.g., such as in a data center or customer premise equipment (CPE)) where many hardware nodes work together and are managed via management and orchestration (MANO) 6100, which, among others, oversees lifecycle management of applications 620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 640 may be a software implementation of a physical machine that runs programs as if they were executing on a physical, non-virtualized machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

In some embodiments, one or more radio units 6200 that each include one or more transmitters 6220 and one or more receivers 6210 may be coupled to one or more antennas 6225. Radio units 6200 may communicate directly with hardware nodes 630 via one or more appropriate network interfaces and may be used in combination with the virtual components to provide a virtual node with radio capabilities, such as a radio access node or a base station.

In some embodiments, some signalling can be effected with the use of control system 6230 which may alternatively be used for communication between the hardware nodes 630 and radio units 6200.

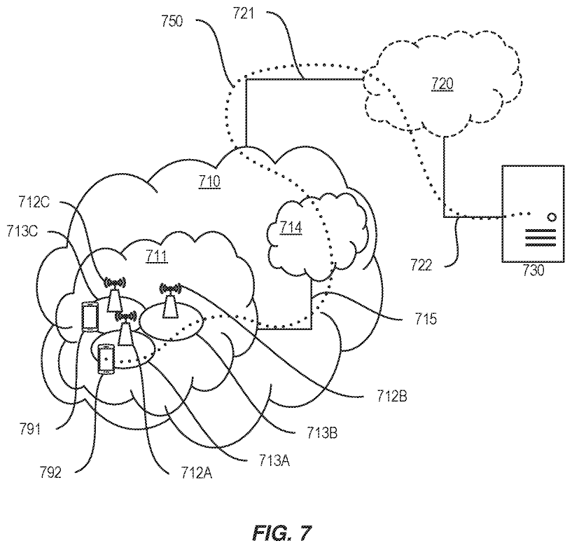

With reference to FIG. 7, in accordance with an embodiment, a communication system includes telecommunication network 710, such as a 3GPP-type cellular network, which comprises access network 711, such as a radio access network, and core network 714. Access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to core network 714 over a wired or wireless connection 715. A first UE 791 located in coverage area 713c is configured to wirelessly connect to, or be paged by, the corresponding base station 712c. A second UE 792 in coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

Telecommunication network 710 is itself connected to host computer 730, which may be embodied in the hardware and/or software of a standalone server, a cloud-implemented server, a distributed server or as processing resources in a server farm. Host computer 730 may be under the ownership or control of a service provider, or may be operated by the service provider or on behalf of the service provider. Connections 721 and 722 between telecommunication network 710 and host computer 730 may extend directly from core network 714 to host computer 730 or may go via an optional intermediate network 720. Intermediate network 720 may be one of, or a combination of more than one of, a public, private or hosted network; intermediate network 720, if any, may be a backbone network or the Internet; in particular, intermediate network 720 may comprise two or more sub-networks (not shown).

The communication system of FIG. 7 as a whole enables connectivity between the connected UEs 791, 792 and host computer 730. The connectivity may be described as an over-the-top (OTT) connection 750. Host computer 730 and the connected UEs 791, 792 are configured to communicate data and/or signaling via OTT connection 750, using access network 711, core network 714, any intermediate network 720 and possible further infrastructure (not shown) as intermediaries. OTT connection 750 may be transparent in the sense that the participating communication devices through which OTT connection 750 passes are unaware of routing of uplink and downlink communications. For example, base station 712 may not or need not be informed about the past routing of an incoming downlink communication with data originating from host computer 730 to be forwarded (e.g., handed over) to a connected UE 791. Similarly, base station 712 need not be aware of the future routing of an outgoing uplink communication originating from the UE 791 towards the host computer 730.

Example implementations, in accordance with an embodiment, of the UE, base station and host computer discussed in the preceding paragraphs will now be described with reference to FIG. 8. In communication system 800, host computer 810 comprises hardware 815 including communication interface 816 configured to set up and maintain a wired or wireless connection with an interface of a different communication device of communication system 800. Host computer 810 further comprises processing circuitry 818, which may have storage and/or processing capabilities. In particular, processing circuitry 818 may comprise one or more programmable processors, application-specific integrated circuits, field programmable gate arrays or combinations of these (not shown) adapted to execute instructions. Host computer 810 further comprises software 811, which is stored in or accessible by host computer 810 and executable by processing circuitry 818. Software 811 includes host application 812. Host application 812 may be operable to provide a service to a remote user, such as UE 830 connecting via OTT connection 850 terminating at UE 830 and host computer 810. In providing the service to the remote user, host application 812 may provide user data which is transmitted using OTT connection 850.

Communication system 800 further includes base station 820 provided in a telecommunication system and comprising hardware 825 enabling it to communicate with host computer 810 and with UE 830. Hardware 825 may include communication interface 826 for setting up and maintaining a wired or wireless connection with an interface of a different communication device of communication system 800, as well as radio interface 827 for setting up and maintaining at least wireless connection 870 with UE 830 located in a coverage area (not shown in FIG. 8) served by base station 820. Communication interface 826 may be configured to facilitate connection 860 to host computer 810. Connection 860 may be direct or it may pass through a core network (not shown in FIG. 8) of the telecommunication system and/or through one or more intermediate networks outside the telecommunication system. In the embodiment shown, hardware 825 of base station 820 further includes processing circuitry 828, which may comprise one or more programmable processors, application-specific integrated circuits, field programmable gate arrays or combinations of these (not shown) adapted to execute instructions. Base station 820 further has software 821 stored internally or accessible via an external connection.

Communication system 800 further includes UE 830 already referred to. Its hardware 835 may include radio interface 837 configured to set up and maintain wireless connection 870 with a base station serving a coverage area in which UE 830 is currently located. Hardware 835 of UE 830 further includes processing circuitry 838, which may comprise one or more programmable processors, application-specific integrated circuits, field programmable gate arrays or combinations of these (not shown) adapted to execute instructions. UE 830 further comprises software 831, which is stored in or accessible by UE 830 and executable by processing circuitry 838. Software 831 includes client application 832. Client application 832 may be operable to provide a service to a human or non-human user via UE 830, with the support of host computer 810. In host computer 810, an executing host application 812 may communicate with the executing client application 832 via OTT connection 850 terminating at UE 830 and host computer 810. In providing the service to the user, client application 832 may receive request data from host application 812 and provide user data in response to the request data. OTT connection 850 may transfer both the request data and the user data. Client application 832 may interact with the user to generate the user data that it provides.

It is noted that host computer 810, base station 820 and UE 830 illustrated in FIG. 8 may be similar or identical to host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, OTT connection 850 has been drawn abstractly to illustrate the communication between host computer 810 and UE 830 via base station 820, without explicit reference to any intermediary devices and the precise routing of messages via these devices. Network infrastructure may determine the routing, which it may be configured to hide from UE 830 or from the service provider operating host computer 810, or both. While OTT connection 850 is active, the network infrastructure may further take decisions by which it dynamically changes the routing (e.g., on the basis of load balancing consideration or reconfiguration of the network).

Wireless connection 870 between UE 830 and base station 820 is in accordance with the teachings of the embodiments described throughout this disclosure. One or more of the various embodiments improve the performance of OTT services provided to UE 830 using OTT connection 850, in which wireless connection 870 forms the last segment. More precisely, the teachings of these embodiments may improve, for example, the data rate, latency, and power consumption and thereby provide benefits such as reduced user waiting time, relaxed restriction on file size, better responsiveness, and extended battery lifetime.

A measurement procedure may be provided for the purpose of monitoring data rate, latency, and other factors on which the one or more embodiments improve. There may further be an optional network functionality for reconfiguring OTT connection 850 between host computer 810 and UE 830, in response to variations in the measurement results. The measurement procedure and/or the network functionality for reconfiguring OTT connection 850 may be implemented in software 811 and hardware 815 of host computer 810 or in software 831 and hardware 835 of UE 830, or both. In embodiments, sensors (not shown) may be deployed in or in association with communication devices through which OTT connection 850 passes; the sensors may participate in the measurement procedure by supplying values of the monitored quantities exemplified above, or supplying values of other physical quantities from which software 811, 831 may compute or estimate the monitored quantities. The reconfiguring of OTT connection 850 may include message format, retransmission settings, preferred routing etc.; the reconfiguring need not affect base station 820, and it may be unknown or imperceptible to base station 820. Such procedures and functionalities may be known and practiced in the art. In certain embodiments, measurements may involve proprietary UE signaling facilitating host computer 810's measurements of throughput, propagation times, latency and the like. The measurements may be implemented in that software 811 and 831 causes messages to be transmitted, in particular empty or ‘dummy’ messages, using OTT connection 850 while it monitors propagation times, errors etc.

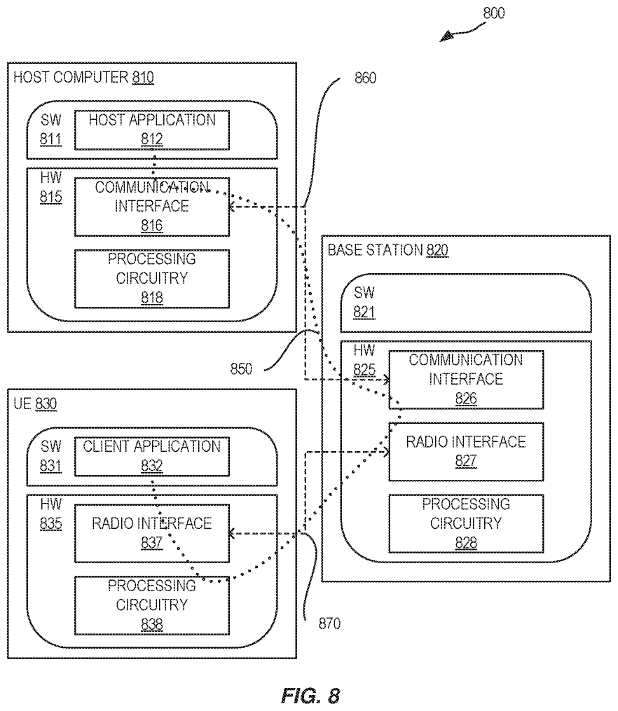

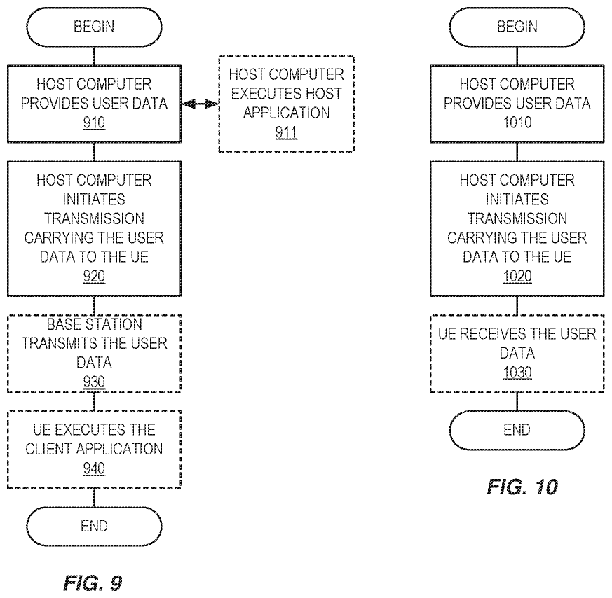

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

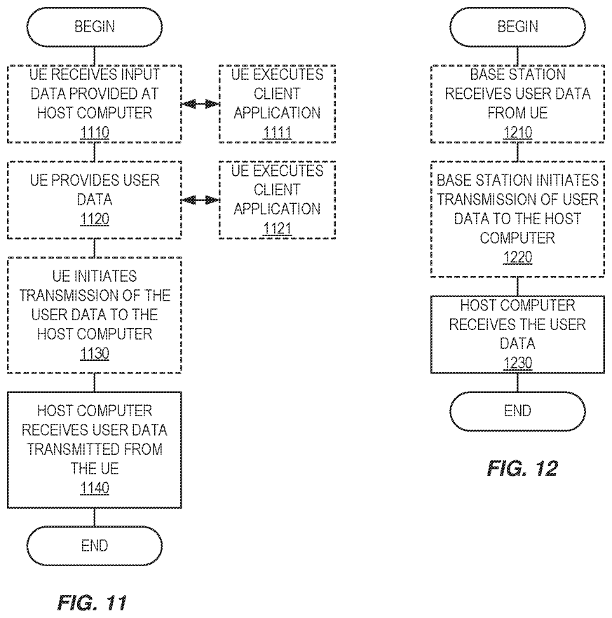

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

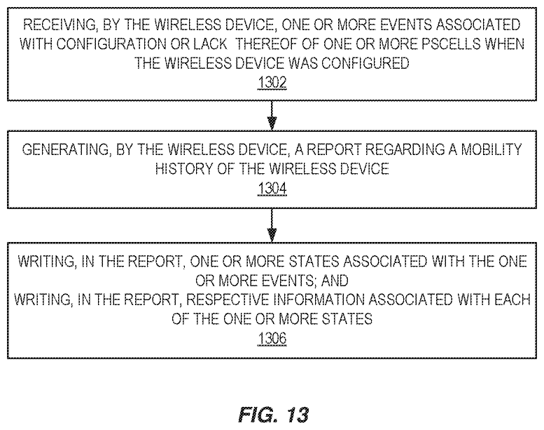

FIG. 13 depicts a method in accordance with particular embodiments with a method performed by a wireless device for allowing tracking of mobility history associated with secondary node operations. The method begins at step 1302 with receiving, by the wireless device, one or more events associated with configuration (or lack thereof) of one or more PSCells when the wireless device was configured. The method continues at 1304 with generating, by the wireless device, a report regarding a mobility history of the wireless device. The writing of the report includes at 1306 writing, in the report, one or more states associated with the one or more events and writing, in the report, respective information associated with each of the one or more states.

In various embodiments, the writing of the report includes writing one or more states that include at least one of: configuration of a PSCell, configuration of a PSCell1, configuration of a PSCell2, and “no SN configuration.” Further, the writing of the report may include, in various embodiments, respective information associated with each of the one or more states is at least one of: a time spent with a certain PSCell configured of the one or more PSCells (or no PSCell configuration), a cause that triggered the wireless device in the state, a cell quality experienced in the state, the mobility state of the wireless device in the state, the mobility state of the mobile device at the first moment of being configured with certain PSCell of the one or more PSCells, the mobility state of the mobile device at the last moment of being configured with a certain PSCell of the one or more PSCells.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some example embodiments of the present disclosure are as follows:

### Group A Embodiments

Embodiment 1: A method performed by a wireless device for allowing tracking of mobility history associated with secondary node operations, the method comprising:
receiving, by the wireless device, one or more events associated with configuration of one or more PSCells when the wireless device was configured;
generating, by the wireless device, a report regarding a mobility history of the wireless device, including:
   writing, in the report, one or more states associated with the one or more events; and
   writing, in the report, respective information associated with each of the one or more states.

Embodiment 2: The method of embodiment 1, wherein the one or more states is: at least one of configuration of a PSCell1 and configuration of a PSCell2 of the one or more PSCells.

Embodiment 3: The method of embodiment 2, wherein the respective information associated with each of the one or more states is at least one of: a time spent with a certain PSCell configured of the one or more PSCells, an indication of the cause that triggered the wireless device in the state, a cell quality experienced in the state, the mobility state of the wireless device in the state, the mobility state of the mobile device at the first moment of being configured with certain PSCell of the one or more PSCells, and the mobility state of the mobile device at the last moment of being configured with a certain PSCell of the one or more PSCells.

Embodiment 4: The method of embodiment 2, wherein configuration of PSCell1 is included in the report when the wireless device is handed over from PSCell1 to PSCell2.

Embodiment 5: The method of embodiment 2, wherein configuration of PSCell1 is included in the report when the wireless devices is handed over from the PCell1 to a PCell2.

Embodiment 6: The method of embodiment 2, wherein configuration of PSCell1 is included in the report when a connection of the wireless device with the PCell is released or lost.

Embodiment 7: The method of embodiment 2, wherein the PSCell1 is included in the report when the PSCell1 is released for the wireless device.

Embodiment 8: The method of embodiment 6, wherein the PSCell1 is released for the wireless device when MR-DC is released.

Embodiment 9: A method performed by a wireless device for allowing tracking of mobility history associated with secondary node operations, the method comprising:
receiving, by the wireless device, one or more events associated with lack of configuration of PSCells when the wireless device was configured;
generating, by the wireless device, a report regarding a mobility history of the wireless device, including:
   writing, in the report, one or more states associated with the one or more events; and
   writing, in the report, respective information associated with each of the one or more states.

Embodiment 10: The method of embodiment 9, wherein the one or more states is no PSCell configuration.

Embodiment 11: The method of embodiment 10, wherein the respective information associated with each of the one or more states is at least one of: a time spent with no PSCell configuration, an indication of the cause that triggered the wireless device in the state, a cell quality experienced in the state, the mobility state of the wireless device in the state.

Embodiment 12: The method of embodiment 10, wherein the PSCell is configured for the wireless device when the wireless device is connected to a certain PCell.

Embodiment 13: The method of embodiment 10, wherein the wireless device performs a handover from a PCell1 to a PCell2 and the wireless device does not have a secondary node configured when the handover is performed.

Embodiment 14: The method of embodiment 10, wherein a connection of the wireless device with a PCell1 is released or lost and the wireless devices does not have a secondary node configured.

Embodiment 15: The method of embodiment 12, wherein the wireless devices does not have the secondary node configured when the PSCell is configured.

Embodiment 16: The method of embodiment 6 or 14, wherein a connection of the wireless device with a PCell1 is released or lost as a result of the wireless device transiting from RRC_CONNECTED mode to RRC_IDLE, or RRC_INACTIVE, or as a result of RLF.

Embodiment 17: The method of any of the above embodiments, wherein the wireless device is in RRC_CONNECTED mode.

Embodiment 18: The method of any of the above the above embodiments wherein the events are arranged in chronological order within the report.

Embodiment 19: The method of any of the previous embodiments wherein writing, in a report, comprises writing a MobilityHistoryReport.

Embodiment 20: The method of any of the previous embodiments, further comprising:
providing user data; and
forwarding the user data to a host computer via the transmission to the base station.

### Group B Embodiments

Embodiment 21: A method performed by a base station for allowing tracking of mobility history associated with secondary node operations, the method comprising writing, by the base station, in a report, events associated with configuration of one or more PSCells that were configured when the wireless device was configured with a PCell.

Embodiment 22: A method performed by a wireless device for allowing tracking of mobility history associated with secondary node operations, the method comprising writing, by the base station, in a report, events associated with no PSCell configuration when the wireless device was configured with a PCell.

Embodiment 23: The method of any of the previous two embodiments, wherein the events are arranged in chronological order within the report.

Embodiment 24: The method of any of the previous three embodiments wherein writing, by the wireless device, in a report, comprises writing, by the wireless device, in a MobilityHistoryReport.

Embodiment 25: The method of any of the previous four embodiments, further comprising:
providing user data; and
forwarding the user data to a host computer via the transmission to the base station.

### Group C Embodiments

Embodiment 26: A wireless device for allowing tracking of mobility history associated with secondary node operations, the wireless device comprising:
processing circuitry configured to perform any of the steps of any of the Group A embodiments; and
power supply circuitry configured to supply power to the wireless device.

Embodiment 27: A base station for allowing tracking of mobility history associated with secondary node operations, the base station comprising:
processing circuitry configured to perform any of the steps of any of the Group B embodiments;
power supply circuitry configured to supply power to the base station.

Embodiment 28: A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

Embodiment 29: The communication system of the previous embodiment further including the base station.

Embodiment 30: The communication system of the previous 2 embodiments, further including the UE, wherein the UE is configured to communicate with the base station.

Embodiment 31: The communication system of the previous 3 embodiments, wherein:
the processing circuitry of the host computer is configured to execute a host application, thereby providing the user data; and
the UE comprises processing circuitry configured to execute a client application associated with the host application.

Embodiment 32: A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

Embodiment 33: The method of the previous embodiment, further comprising, at the base station, transmitting the user data.

Embodiment 34: The method of the previous 2 embodiments, wherein the user data is provided at the host computer by executing a host application, the method further comprising, at the UE, executing a client application associated with the host application.

Embodiment 35: A user equipment (UE) configured to communicate with a base station, the UE comprising a radio interface and processing circuitry configured to performs the of the previous 3 embodiments.

Embodiment 36: A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

Embodiment 37: The communication system of the previous embodiment, wherein the cellular network further includes a base station configured to communicate with the UE.

Embodiment 38: The communication system of the previous 2 embodiments, wherein:
the processing circuitry of the host computer is configured to execute a host application, thereby providing the user data; and
the UE's processing circuitry is configured to execute a client application associated with the host application.

Embodiment 39: A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

Embodiment 40: The method of the previous embodiment, further comprising at the UE, receiving the user data from the base station.

Embodiment 41: A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

Embodiment 42: The communication system of the previous embodiment, further including the UE.

Embodiment 43: The communication system of the previous 2 embodiments, further including the base station, wherein the base station comprises a radio interface configured to communicate with the UE and a communication interface configured to forward to the host computer the user data carried by a transmission from the UE to the base station.

Embodiment 44: The communication system of the previous 3 embodiments, wherein:
the processing circuitry of the host computer is configured to execute a host application; and
the UE's processing circuitry is configured to execute a client application associated with the host application, thereby providing the user data.

Embodiment 45: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 46: A method implemented in a communication system including a host computer, a base station and a user equipment (UE), the method comprising, at the host computer, receiving user data transmitted to the base station from the UE, wherein the UE performs any of the steps of any of the Group A embodiments.

Embodiment 47: The method of the previous embodiment, further comprising, at the UE, providing the user data to the base station.

Embodiment 48: The method of the previous 2 embodiments, further comprising:
at the UE, executing a client application, thereby providing the user data to be transmitted; and
at the host computer, executing a host application associated with the client application.

Embodiment 49: The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

Embodiment 50: A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

Embodiment 51: The communication system of the previous embodiment further including the base station.

Embodiment 52: The communication system of the previous 2 embodiments, further including the UE, wherein the UE is configured to communicate with the base station.

Embodiment 53: The communication system of the previous 3 embodiments, wherein:
the processing circuitry of the host computer is configured to execute a host application;
the UE is configured to execute a client application associated with the host application, thereby providing the user data to be received by the host computer.

Embodiment 54: A method implemented in a communication system including a host computer, a base station and a user equipment (UE), the method comprising, at the host computer, receiving, from the base station, user data originating from a transmission which the base station has received from the UE, wherein the UE performs any of the steps of any of the Group A embodiments.

Embodiment 55: The method of the previous embodiment, further comprising at the base station, receiving the user data from the UE.

Embodiment 56: The method of the previous 2 embodiments, further comprising at the base station, initiating a transmission of the received user data to the host computer.

1-20. (canceled)

21. A method performed by a wireless device, the method comprising:
generating a report that comprises mobility history information, the mobility history information comprising, for a certain Primary Cell (PCell) with which the wireless device is or was configured, information related to one or more Secondary Node (SN) related operations, wherein the information related to the one or more SN related operations comprises information that indicates whether the wireless device was configured with a SN or not while being configured with the certain PCell; and
sending the report to a network node.

22. The method of claim 0, wherein the one or more SN related operations comprises:
any one or combination of two or more of:
a SN modification, a SN change, removal of a Primary Secondary Cell (PSCell) configuration for the wireless device, addition of a PSCell configuration for the wireless device, and/or the wireless device not being configured with the SN.

23. The method of claim 0, wherein the information related to the one or more SN related operations comprises a mobility history of the wireless device associated to the one or more SN related operations.

24. The method of claim 0, wherein the information related to the one or more SN related operations comprises a list that comprises one or more entries, each of the one or more entries comprising information that indicates a PSCell visited by the wireless device while being configured with the certain PCell or information that indicates no SN configuration.

25. The method of claim 0, wherein the list is in chronological order.

26. The method of claim 0, wherein the list further comprises one or more entries that indicate one or more PSCells visited by the wireless device while being configured with the certain PCell and one or more entries that indicates no SN configuration.

27. The method of claim 0, wherein the information related to the one or more SN related operations further comprises information collected by the wireless device related to each entry in the list.

28. The method of claim 0, wherein the information collected by the wireless device related to each entry in the list comprises:
any one or combination of two or more of:
an amount of time spent in a respective PSCell or an amount of time spent with no SN configuration;
an indication of a cause that triggers the wireless device into a respective PSCell to into having no SN configuration;
cell quality experienced in a respective PSCell;
a mobility state of the wireless device;
a mobility state of the wireless device at a first moment of being configured with a respective PSCell or with no SN configuration; and/or
a mobility state of the wireless device at a last moment of being configured with a respective PSCell or with no SN configuration.

29. The method of claim 0, wherein the information related to the one or more SN related operations comprises, in chronological order, states related to the one or more SN related operations while the wireless device is or was configured with the certain PCell.

30. The method of claim 0, wherein the states related to the one or more SN related operations comprise one or more states in which the wireless device is configured with a PSCell and one or more states in which the wireless device has no SN configuration.

31. The method of claim 0, wherein the information related to the one or more SN related operations further comprises, for each of the states related to the one or more SN related operations:
any one or combination of two or more of:
an amount of time spent in the state;
an indication of a cause that triggers the wireless device into the state;
cell quality experienced in the state;
a mobility state of the wireless device in the state;
a mobility state of the wireless device at a first moment of being configured with a respective PSCell for the state; and/or
a mobility state of the wireless device at a last moment of being configured with a respective PSCell for the state.

32. A wireless device for a wireless network, the wireless device comprising:
processing circuitry; and
memory containing instructions executable by the processing circuitry whereby the wireless device is operative to:
generate a report that comprises mobility history information, the mobility history information comprising, for a certain Primary Cell (PCell) with which the wireless device is or was configured, information related to one or more Secondary Node (SN) related operations, wherein the information related to the one or more SN related operations comprises information that indicates whether the wireless device was configured with a SN or not while being configured with the certain PCell; and
send the report to a network node.

33. The wireless device of claim 0, wherein the one or more SN related operations comprise:
any one or combination of two or more of:
an SN modification, an SN change, removal of a Primary Secondary Cell (PSCell) configuration for the wireless device, addition of a PSCell configuration for the wireless device, and/or the wireless device not being configured with the SN.

34. The wireless device of claim 0, wherein the information related to the one or more SN related operations comprises a mobility history of the wireless device associated to the one or more SN related operations.

35. The wireless device of claim 0, wherein the information related to the one or more SN related operations comprises a list that comprises one or more entries, each of the one or more entries comprising information that indicates PSCell visited by the wireless device while being configured with the certain PCell or information that indicates no SN configuration.

36. The wireless device of claim 0, wherein the list is in chronological order.

37. The wireless device of claim 0, wherein the list further comprises one or more entries that indicate one or more PSCells visited by the wireless device while being configured with the certain PCell and one or more entries that indicates no SN configuration.

38. The wireless device of claim 0, wherein the information related to the one or more SN related operations further comprises information collected by the wireless device related to each entry in the list of.

39. The wireless device of claim 0, wherein the information collected by the wireless device related to each entry in the list comprises:
any one or combination of two or more of:
an amount of time spent in a respective PSCell or an amount of time spent with no SN configuration;
an indication of a cause that triggers the wireless device into a respective PSCell to into having no SN configuration;
cell quality experienced in a respective PSCell;
a mobility state of the wireless device;
a mobility state of the wireless device at a first moment of being configured with a respective PSCell or with no SN configuration; and/or
a mobility state of the wireless device at a last moment of being configured with a respective PSCell or with no SN configuration.

40. The wireless device of claim 0, wherein the wireless device further comprises: radio front end circuitry, wherein the processing circuitry is associated with the radio front end circuitry.
